(19) United States
(12) Patent Application Publication
(10) Pub. No.: US 2018/0300542 A1
(43) Pub. Date: Oct. 18, 2018

(54) DRAWING EMOJIS FOR INSERTION INTO ELECTRONIC TEXT-BASED MESSAGES

(71) Applicant: Nuance Communications, Inc., Burlington, MA (US)

(72) Inventors: Gordon Robert Waddell, Seattle, WA (US); Amanjot Singh, Seattle, WA (US); David J. Kay, Seattle, WA (US)

(21) Appl. No.: 15/490,266

(22) Filed: Apr. 18, 2017

(51) Int. Cl. G06K 9/00; G06F 17/24; G06F 3/0488; G06F 3/0482

(52) U.S. Cl. CPC G06K 9/00436; G06F 17/242; G06F 2203/04808; G06F 3/04883; G06F 3/0482; G06K 9/00416

(57) ABSTRACT

A system and method for enabling users to draw emojis for insertion into electronic text-based messages are disclosed. The system receives a handwritten drawing input from a user composing an electronic text based message on a computing device. The handwritten drawing input is to represent an emoji for insertion into the message, and comprises a series of strokes input to the computing device by the user. The system analyzes the series of strokes and matches the analyzed series of strokes to at least one emoji in a set of emojis. The user can then select the at least one emoji for insertion into the message.

### BACKGROUND

Users often supplement electronic text-based messages (e.g., text messages, email messages, instant messages, chats, and so on) with pictorial elements to add an emotional or tonal context to textual content of the message or to replace colloquial language expressions. In particular, pictorial elements known as emojis have gained widespread popularity among users of computing devices. Due to their graphical nature, emojis are generally considered a language-neutral pictorial language distinct from specific languages, such as English, Chinese, etc. Hence, irrespective of a native language of a user, the user can simply insert an emoji into their message to convey content that can be understood by various speakers.

However, due to their popularity, the number of emojis available for selection by a user has been steadily increasing. For example, under the Unicode standard, new emoji definitions are normally released every year. Hence, searching for a desired emoji can be often time consuming for a user. Furthermore, graphical user interfaces (GUIs) of computing devices, such as those of smartphones, often do not make it particularly easy to find and choose a desired emoji. For instance, when a user is composing an electronic text-based message, the user often has to navigate or swipe through multiple screens and a multitude of emojis in order to find an emoji for insertion into the message.

### BRIEF DESCRIPTION OF THE DRAWINGS

Embodiments, examples, and implementations of the present technology will be described and explained through the use of the accompanying drawings in which:

FIG. 1 is a block diagram illustrating an example of a computing environment in which a hand-drawn emoji matching system may be utilized;

FIG. 2 illustrates an example of a handwritten drawing input received by the hand-drawn emoji matching system and a corresponding output provided by the system;

FIG. 3 is a block diagram depicting a set of components of the hand-drawn emoji matching system;

FIG. 4 is a flow diagram illustrating a method for matching hand-drawn emojis to emojis;

FIG. 5 is a flow diagram illustrating a method for matching handwritten drawing strokes to emojis;

FIG. 6A illustrates a touch-sensitive mobile device on which a user provides a handwritten drawing input;

FIGS. 6B-6D illustrate examples of a user interface of the touch-sensitive mobile device of FIG. 6A for presenting matching emojis based on the handwritten drawing input;

FIGS. 7A-7D illustrate additional examples of a user interface of a touch-sensitive mobile device for presenting a matching emoji based on a hand-drawn emoji representation; and

FIG. 8 is a simplified system block diagram of hardware components of a touch-sensitive device for implementing the hand-drawn emoji matching system.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

### Overview

The present disclosure provides a detailed description of a system to facilitate selection of emojis for insertion into electronic text-based messages. With the present technology, a user can draw a desired emoji and the system can identify one or more emoji(s) matching the hand-drawn emoji for user selection and insertion into an electronic text-based message. In this regard, the system can be configured to search for and identify matching emojis based, for instance, on hand-drawn representations of the emojis that could be predetermined or learned (e.g., learned from an actual use of the system by users). The matching emoji options may be presented to the user as or after the user draws the emoji. As such, the user may be able to find and select the desired emoji quicker than in traditional methods, because a complete drawing or series of strokes does not need to be completed before one or more emojis are presented to the user.

More particularly, the system disclosed herein uses aspects of handwriting recognition to provide emoji options to a user to choose from based on a handwritten drawing input of the user. In some embodiments, the system receives from the user composing an electronic text-based message on a computing device a handwritten drawing input that is to represent an emoji to be inserted into the message. The handwritten drawing input comprises a series of strokes. After or as the user inputs the series of strokes into the computing device, the system analyzes the series of strokes and matches the analyzed series of strokes to one or more emojis in a set of emojis. In certain embodiments, the set of emojis may be held in a database that stores stroke data associated with corresponding emoji characters.

Further, the system can present the emojis to the user, and the user can select emoji(s) to be inserted into the electronic text-based message. According to some embodiments, the system can automatically present the user with matching emoji options as the strokes are being input by the user. Accordingly, as the user inputs more strokes, the system may present the user with more relevant emoji options to select from. Further, with a benefit of this embodiment, the user may be able to find a desired emoji even before the user draws all of the strokes intended to represent the desired emoji.

Various examples of the invention will now be described. The following description provides specific details for a thorough understanding and enabling description of these examples. One skilled in the relevant art will understand, however, that the invention may be practiced without many of these details. Likewise, one skilled in the relevant art will also understand that the invention may include many other obvious features not described in detail herein. Additionally, some well-known structures or functions may not be shown or described in detail below, so as to avoid unnecessarily obscuring the relevant description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

### Illustrative Computing Environment

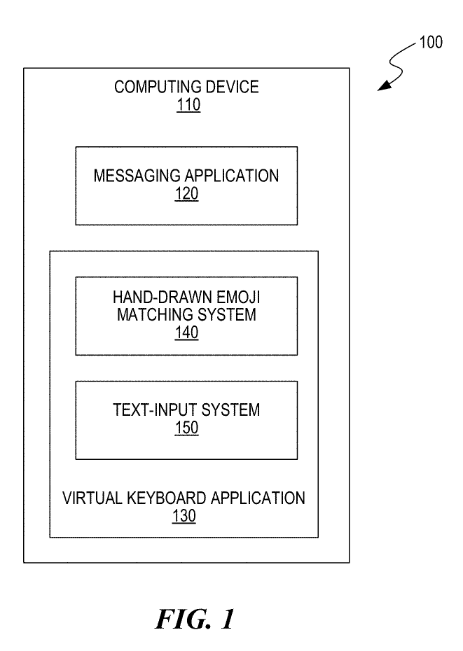

FIG. 1 is a block diagram illustrating an example of a computing environment in which a hand-drawn emoji matching system may be utilized. As illustrated in FIG. 1, a computing environment 100 comprises a computing device 110 that includes a messaging application 120 and a virtual keyboard application 130. Further, the virtual keyboard application 130 includes a hand-drawn emoji matching system 140 and a text-input system 150.

In general, the computing device 110 may be any computing device equipped with suitable hardware, software, and/or firmware to provide various functionality of the hand-drawn emoji matching system 140 as described herein. Some examples of the computing device 110 include a mobile/cellular phone, a smartphone, a tablet computer, a laptop, a vehicle-based computer, a wearable computing device, and so on. In illustrative embodiments, the computing device 110 is equipped with one or more input and output components (e.g., a keypad, a keyboard, a touchscreen, a mouse, a microphone, a display, pen/stylus and tablet, etc.) for interaction with a user. Among others, the interaction includes receiving user inputs to compose an electronic text-based message via the messaging application 120 and the virtual keyboard application 130. In this regard, the messaging application 120 will generally provide a text field into which the user inputs text and/or other characters.

In particular, the computing device 110 includes one or more input devices via which a user can provide a text input for processing by the text-input system 150 and a handwritten drawing input for processing by the hand-drawn emoji matching system 140. One typical method to provide inputs into the virtual keyboard application 130 is via a touchscreen interface using a user's finger or another input mechanism, such as a stylus. As such, the computing device 110 may be equipped with a touchscreen that may be part of a display or separate from the display. The touchscreen may be any suitable type of touchscreen configured to sense handwritten drawing inputs, some examples of which include a capacitive touchscreen and a resistive touchscreen. In other embodiments, input devices may include, for example, a touchpad (or trackpad), a mouse (to provide, e.g., free-style handwriting inputs on a display screen), or any other suitable input device (e.g. a wearable input device).

The virtual keyboard application 130 may interact with various applications supported by the computing device 110, such as the messaging application 120 (e.g., a text messaging application (e.g., a Short Messaging Service (SMS) application), an email application, a chat application, an instant messaging application, and/or so on), that enables users to exchange text-based communications. In this regard, the text-input system 150 may be configured to receive inputs from a user and produce a text string or text-based message for display to the user.

As a general matter, the virtual keyboard application 130 may be used with many applications executed on the computing device 110 that require text inputs from a user. In particular, the virtual keyboard application 130 adapted for use with mobile devices, such as smartphones or tablets, will often provide characters for text entry, as well as emojis for insertion into messages in addition to text. For instance, by selecting an emoji symbol on a virtual keyboard, a user may be presented with various emoji options to select from. Hence, the virtual keyboard application 130 may be an appropriate application for incorporating functionality associated with the hand-drawn emoji matching system 140.

Hence, in the embodiment shown in FIG. 1, the virtual keyboard application 130 includes the hand-drawn emoji matching system 140. Note, however, that in other embodiments, the hand-drawn emoji matching system 140 may be integrated with any other suitable text-input application, the messaging application 120 itself, or as a stand-alone application within an operating system of the computing device 110. Accordingly, the hand-drawn emoji matching system 140 may be implemented on computing devices that lack, for example, virtual keyboard capability. Further, in certain embodiments, the hand-drawn emoji matching system 140 may also be implemented in conjunction with any suitable text-input method, such as a method using a secondary input mechanism external to the computing device 110 (e.g., an external graphics/pen tablet), an application that enables a stylus to be used in a freehand input mode, and so on.

In operation, a user composing an electronic text-based message via the messaging application 120 and the virtual keyboard application 130 may desire to insert a given emoji into that message. For example, to emphasize a humorous tone of the message, the user may want to insert a given smiling-face emoji (commonly referred to as a “smiley”) into the message.

The hand-drawn emoji matching system 140 is configured to identify emoji(s) to present to the user composing the electronic text-based message based on a handwritten drawing input received from a user. More specifically, the hand-drawn emoji matching system 140 is configured to receive from the user the handwritten drawing input that is to represent an emoji to be inserted into the electronic text-based message being composed by the user. The handwritten drawing input may comprise a series of strokes input by the user into the computing device 110. In turn, the hand-drawn emoji matching system 140 is further configured to analyze the series of strokes, and match the analyzed series of strokes to one or more emojis that the user can select for insertion into the electronic text-based message.

As will be illustrated in more detail, in some embodiments, the hand-drawn emoji matching system 140 may be configured to dynamically analyze and match the handwritten drawing input to one or more emojis as the stroke(s) of the handwritten drawing input are being received from the user. More specifically, the series of strokes input by the user into the computing device 110 may include a number of strokes that are input sequentially so that the hand-drawn emoji matching system 140 receives a first stroke, thereafter receives a second stroke, and so on. Each of the first and second strokes may be a single stroke or a set of strokes (e.g., a set of strokes associated with a given shape).

In response to the receipt of the first stroke of the handwritten drawing input, the hand-drawn emoji matching system 140 matches the first stroke to one or more first emojis. The hand-drawn emoji matching system 140 may be further configured to automatically present to the user the first emoji(s) matched by the system 140 to the first stroke. Subsequently, in response to the receipt of the second stroke of the handwritten drawing input, the hand-drawn emoji matching system 140 matches the first stroke and the second stroke to one or more second emojis. The hand-drawn emoji matching system 140 may be further configured to automatically present to the user the second emoji(s) matched by the system 140 to the first stroke and the second stroke. Accordingly, when the hand-drawn emoji matching system 140 processes together more strokes (e.g., the first stroke and the second stroke), the hand-drawn emoji matching system 140 may increase a likelihood of identifying emoji options that are likely to include an emoji desired by the user.

The second emoji(s) presented may include at least one emoji different from the first emoji(s) presented. Alternatively or additionally, the second emoji(s) may be a subset of the first emojis. For example, after the hand-drawn emoji matching system 140 processes the second stroke, the system 140 may eliminate some emoji(s) from a set of multiple first emojis. Based on the additional stroke(s), the eliminated emoji(s) may no longer be relevant.

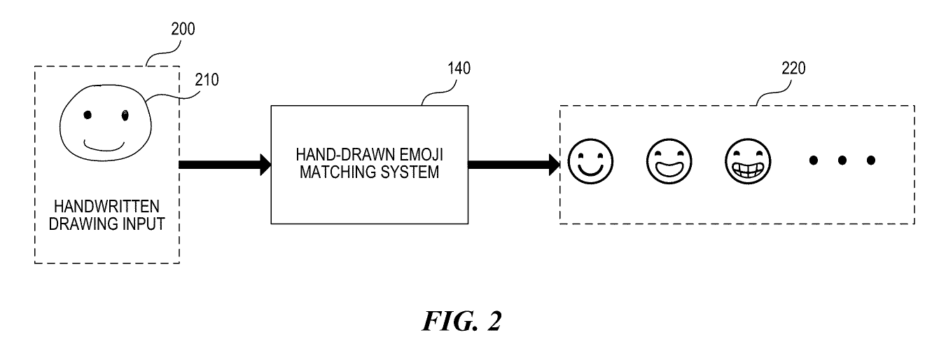

FIG. 2 illustrates an example of a handwritten drawing input received by the hand-drawn emoji matching system 140 and a corresponding output provided by the system 140.

As shown in the example of FIG. 2, to represent a “smiley,” the user may provide a handwritten drawing input 200 including a series of strokes 210 that correspond to a circle, two dots, and a curved line. The hand-drawn emoji matching system 140 is configured to analyze the series of strokes 210 in the handwritten drawing input 200, and to match the analyzed series of strokes to at least one emoji selectable by the user. For example, as shown in FIG. 2, the hand-drawn emoji matching system 140 may output one or more matching “smiley” emojis 220 from a set of emojis available to the hand-drawn emoji matching system 140.

As described above, in some embodiments, the hand-drawn emoji matching system 140 may be configured to dynamically identify potential emoji matches as the strokes 210 are being drawn by the user.

For instance, in the context of the example of FIG. 2, after the user draws one or more strokes of the series of strokes 210 (e.g., one or more strokes corresponding to the circle), the hand-drawn emoji matching system 140 may find and output all emojis whose features include a circle. The output emojis may be presented to the user in a row, ordered in decreasing popularity, so that, e.g. the most common emoji having a circle is leftmost, followed by the next most common emoji having a circle, and so on. Thus, the system may track usage statistics of all emojis input by a user, by all users, or combined statistics of all users, but weighted toward emojis more commonly input by each user.

As the user draws additional stroke(s) in the series of strokes 210, the hand-drawn emoji matching system 140 may continue to search for and identify matching emojis (e.g., narrow down the search results to provide more relevant emojis as additional strokes are being input by the user) until the handwritten drawing input 200 is completed. However, in other embodiments, the hand-drawn emoji matching system 140 may be configured to output one or more matching emojis only after the user completes inputting all of the strokes 210.

Accordingly, the hand-drawn emoji matching system 140 enables the user to find an emoji for insertion into the electronic text-based message based on a user-provided hand-drawn representation of the emoji. For instance, in the example of FIG. 2, the hand-drawn emoji matching system 140 matches the user's handwritten drawing input 200 to the “smiley” emojis 220 from which the user can select an emoji for insertion into the electronic text-based message.

Further details regarding operation and implementation of the hand-drawn emoji matching system 140 will now be described.

### Illustrative Hand-Drawn Emoii Matching System

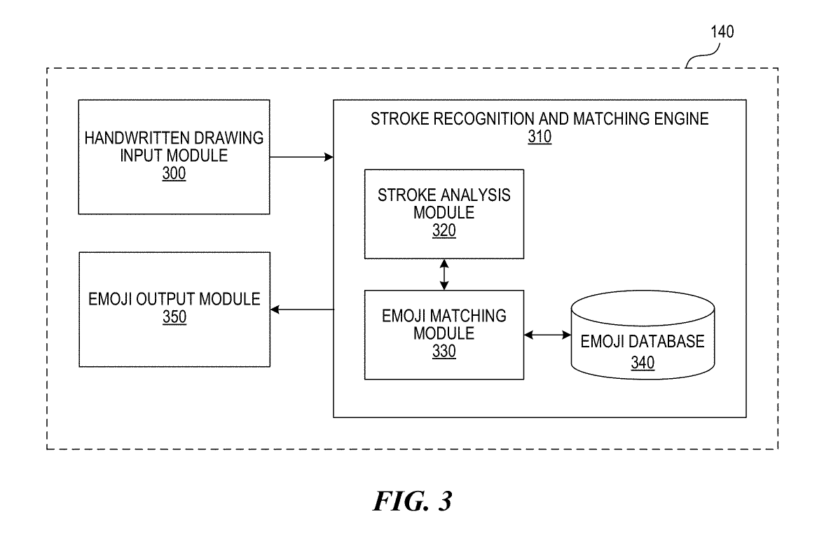

FIG. 3 is a block diagram illustrating a set of components of the hand-drawn emoji matching system 140 configured to perform various functions described herein. As depicted in FIG. 3, the hand-drawn emoji matching system 140 comprises a handwritten drawing input module 300, a stroke recognition and matching engine 310, and an emoji output module 350. Further, the stroke recognition and matching engine 310 includes a stroke analysis module 320, an emoji matching module 330, and an emoji database 340. However, in other embodiments, the hand-drawn emoji matching system 140 may instead or in addition include other components than those shown in FIG. 2.

Each of the components depicted in FIG. 3 may be implemented by a suitable combination of software/firmware and hardware, such as by program instructions stored in a memory (e.g., a non-transitory computer-readable storage medium) and executable by one or more processors (e.g., processor(s) embedded in a computing device, such as the computing device 110). Additionally, the memory may store any other data, such as data used by the processor(s) in the execution of the program instructions. Any additional data may also be held in other data storage location(s) separate from the memory. Further, the components of the hand-drawn emoji matching system 140 may be co-located or distributed physically and/or logically across a number of different entities, such as across one or more data storage devices. As an example, the emoji matching module 330 may be co-located with or separate from the emoji database 340.

In illustrative embodiments, the handwritten drawing input module 300 is configured to receive input data corresponding to a handwritten drawing input provided by a user composing an electronic text-based message on a computing device, and to send the input data to the stroke analysis module 320. As noted above, the handwritten drawing input comprises a series of strokes input to the computing device by the user, and is to represent an emoji for insertion into the electronic text-based message. The series of strokes may be one or more strokes.

By way of example, the handwritten drawing input may be in the form of a touch input received via a touch-sensitive display surface of the computing device. In some embodiments, the hand-drawn emoji matching system 140 may support multi-touch input. For example, the hand-drawn emoji matching system 140 may accept two or more strokes drawn simultaneously using two or more fingers.

As a general matter, in handwriting recognition, a stroke may include one or more points typically drawn without lifting a drawing means (e.g., a pen, finger). Various shapes may be drawn using one or more strokes. For example, a line may be drawn with a single stroke, a curve may be drawn with one or more strokes, and so on. For instance, to draw an emoji containing a circle, the user may draw the circle using one continuous stroke or multiple curves each including one or more strokes. Each point of the stroke may be represented by an x-y coordinate denoting a location of the point on a drawing surface, such as a touch-sensitive surface of a computing device, represented as a vector with starting and ending x-y coordinates, or by other means. Hence, the input data processed by the handwritten drawing input module 300 may include any suitable digital representation of the series of strokes drawn by a user (e.g., data representing points corresponding to the handwritten stroke(s)).

The handwritten drawing input module 300 is configured to pass the input data to the stroke recognition and matching engine 310. Namely, the stroke analysis module 320 is configured to receive the input data representing the series of strokes from the handwritten drawing input module 300 and to analyze the series of strokes. The analyzed series of strokes are then matched by the emoji matching module 330 to at least one emoji in a set of emojis stored in the emoji database 340.

The stroke analysis module 320 may be configured to analyze the series of strokes of the handwritten drawing input to identify or detect one or more individual strokes and/or a set of strokes (i.e., two or more strokes). This could be done by, e.g., detecting break points between strokes or using any other suitable technique(s) used in handwriting recognition. Individual strokes and/or respective stroke sets may be defined to represent corresponding shapes (e.g., a straight line, a curve, a triangle, rectangle, circle, etc.). Further, in certain embodiments, the stroke analysis module 320 may be configured to identify an order in which multiple strokes are input by the user to draw a given emoji representation. Note that, in some implementations, various functions of the handwritten drawing input module 300 and/or the stroke analysis module 320 described herein may be implemented using any suitable commercially available handwriting recognition system, such as T9 Write™ system from Nuance Corporation, that provides handwriting recognition functions.

As the handwritten drawing input is received from the user, the emoji matching module 330 is configured to match the analyzed series of strokes to at least one emoji in a set of emojis held in the emoji database 340. In this regard, the stroke analysis module 320 may be configured to provide any suitable data indicative of the analyzed stroke(s) to the emoji matching module 330. In some embodiments, strokes may be analyzed and provided to the emoji matching module 330 on an on-going basis, or dynamically, as the strokes are being input to the computing device by the user. As such, the emoji matching module 330 can dynamically search the emoji database 340 to identify matching emoji(s) as additional strokes are being drawn by the user and processed by the stroke analysis module 320.

Alternatively, strokes may be analyzed and provided to the emoji matching module 330 after the handwritten drawing input is completed by the user. Accordingly, in those embodiments, the emoji matching module 330 may be configured to match the analyzed series of strokes to one or more emojis after all of the strokes are received from the user and processed by the stroke analysis module 320. To determine whether the user has completed inputting strokes into the computing device, the stroke analysis module 320 may be configured to detect a predetermined period of time during which no additional stroke is input by the user to the computing device.

As noted above, the emoji matching module 330 matches the analyzed series of strokes to at least one emoji in the set of emojis stored in the emoji database 340. In some embodiments, the emoji database 340 may be configured to store stroke data associated with corresponding emoji characters. For instance, for a given emoji character, the emoji database 340 may store a corresponding stroke data indicating strokes predetermined to represent at least some of the features of the given emoji character. As an example, each “smiley” emoji may be associated with stroke data indicative of at least a series of strokes corresponding to a circle and two dots inside the circle. To further distinguish between different “smiley” emojis, respective stroke datasets may include additional stroke data representative of distinctive features that differentiate those emojis.

Further, each emoji character may be associated with more than one stroke dataset to reflect variations in how users may draw that particular emoji. Further, variations may exist as to the order in which different users draw a series of strokes to represent a given emoji. As an example, to represent a “smiley” emoji, a first user may first draw two dots and then draw a circle enclosing the dots. A second user, on the other hand, may first draw a circle and then draw two dots inside the circle.

In some implementations, the emoji database 340 may store multiple emoji templates corresponding to respective emoji characters. Each emoji template may correspond to a model of an emoji and include (1) a Unicode value of the emoji it represents and (2) stroke data indicative of one or more strokes predetermined to represent feature and/or shape properties of the emoji. As noted above, variations may exist in how users draw a particular emoji. Hence, a Unicode value of a given emoji character may be associated with multiple emoji templates to account for variations in stroke representation (and hence different stroke data) of that emoji. Thus the multiple emoji templates may include the same Unicode value but include different stroke data associated with the given emoji character.

In general, the present technology expands on current handwriting recognition technology to treat emojis as a separate script. As known in the art, handwriting recognition engines may map typical scripts, such as Latin or Cyrillic, to letters and words in various languages. In operation, the stroke recognition and matching engine 310 can be a handwriting recognition engine that is modified or “trained” to recognize key emoji features/elements in terms of paths or strokes to distinguish between different emoji characters. In some embodiments, the engine 310 is configured to learn a series of strokes, provided in different orders for example, that are likely to represent a given emoji.

The learning process may involve crowd-based learning of stroke order, preference, shape, etc. as part of building database script of emoji representations. More specifically, the learning process may involve collecting data from a test group of a relatively large number of individuals. The collected data could be utilized, for example, to determine the most common stroke sequences used to represent respective emojis for inclusion in the emoji database 340. For example, a stroke representation of a “pizza slice” emoji could be determined based on collecting and analyzing handwritten drawing input data reflecting how most users draw a pizza slice (e.g., a triangle or an acute angle with dots). Unlike typical handwriting recognition training, the data collection could be simplified given that emojis are typically language neutral, and hence, hand-drawn representations of many emojis will typically be similar across many users, irrespective of their native spoken language.

The emoji database 340 may be updated based on an ongoing analysis and a collection of data from the actual use of the hand-drawn emoji matching system 140 (e.g., frequent-use matches, user's stroke preference and order, etc.). As an example, the system 140 may be configured (e.g., programmed) to collect and store information regarding stroke data corresponding to a given handwritten drawing input received from the user and one or more actual emojis selected by the user in response to that given handwritten drawing input. The system 140 may be further configured to periodically provide that information, e.g., via a computing device on which it resides, to a remote entity, such as a server for instance. Such information may be centrally collected from multiple computing devices, analyzed, and the emoji database 340 may be remotely updated by sending periodic application updates to computing devices having the system 140 thereon.

In other embodiments, the hand-drawn emoji matching system 140 may support dynamic databases under which the user can create custom templates. For example, the user may draw a shape intended to represent a given emoji (e.g., an umbrella), and the system 140 may be configured to enable the user to associate a series of strokes corresponding to the drawn shape with an emoji selected by the user. In this regard, the system 140 may be configured to store custom emoji templates in a local custom database separate from the database 340 or in the database 340 itself.

Once the emoji matching module 330 identifies at least one emoji matching the analyzed series of strokes of the handwritten drawing input, the emoji output module 350 is configured to output that emoji(s) to be presented to the user (e.g., one or more of the “smiley” emojis, as shown by way of example in FIG. 2). Subsequently, the user can select one or more emojis for insertion into the message.

As will be described in more detail and illustrated with examples, in some embodiments, the matching and presentation process may be dynamic as the strokes are being drawn by the user. In this regard, as the user inputs additional stroke(s), emoji matches presented to the user may change dynamically. For example, as noted above, after the hand-drawn emoji matching system 140 processes additional stroke(s), the system 140 may eliminate some emoji(s) from a set of emojis matched to previously-input stroke(s) (e.g., the eliminated emoji(s) may no longer be relevant based on the additional stroke(s)).

### Illustrative Process

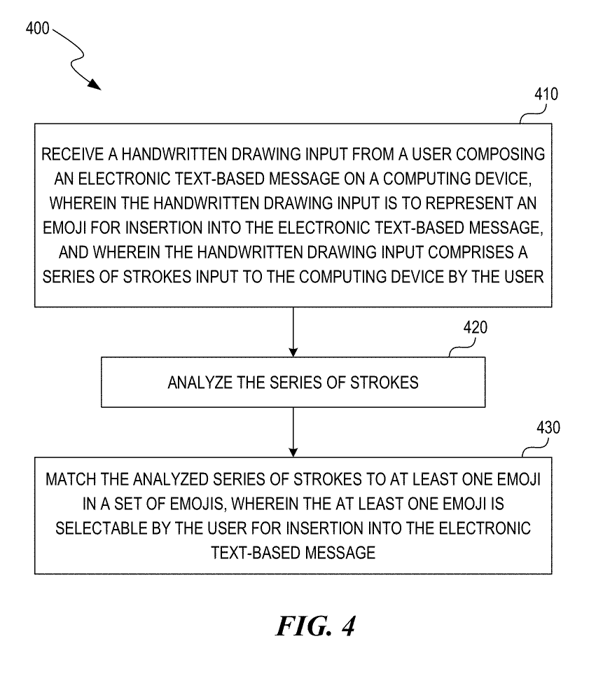

FIG. 4 is a flow diagram illustrating a method 400 for matching hand-drawn emojis to emojis. By way of example herein, the method 400 is performed by the hand-drawn emoji matching system 140. However, in other embodiments, the method 400 may be performed by any suitable processing system (e.g., implemented in the form of processor(s) and stored program instructions executed by the processor(s)) arranged to carry out functions of the method 400.

At block 410, the hand-drawn emoji matching system 140 receives a handwritten drawing input from a user composing an electronic text-based message on a computing device. The handwritten drawing input is to represent an emoji for insertion into the electronic text-based message, and comprises a series of strokes input to the computing device by the user.

At block 420, the hand-drawn emoji matching system 140 analyzes the series of strokes. Then, at block 430, the hand-drawn emoji matching system 140 matches the analyzed series of strokes to at least one emoji in a set of emojis that is selectable by the user for insertion into the electronic text-based message. The matching emoji(s) identified by the hand-drawn emoji matching system 140 may be then presented to the user for selection and insertion into the message.

The hand-drawn emoji matching system 140 may be configured to present emoji matches in a manner that helps a user to distinguish between different categories of emojis present in the set of emojis, where that set is relatively large. As an example, as the user inputs strokes that initially match to emojis corresponding, e.g., to a face-like emoji, a soccer ball emoji, and an apple emoji, the system 140 may be configured to organize results for display to the user in accordance with respective emoji categories corresponding to those initial emoji matches.

In the present example, the hand-drawn emoji matching system 140 may be configured to determine that the respective categories are a facial-expression category, a sports-equipment category, and a food category. As the user inputs additional stroke(s), the system 140 may present subsequent emoji matches organized in any suitable manner according to those categories. For instance, in the present example, the system 140 may present a first group of multiple facial-expression emojis corresponding to the facial-expression category, a second group of balls and other sports equipment emojis (e.g. a baseball, a volleyball, a tennis ball, etc.) corresponding to the sports-equipment category, and a third group of fruit/food emojis (e.g., a plum, a peach, etc.) corresponding to the food category. Hence, as the set of emojis used by the system 140 increases, matching emojis may be organized for presentation to the user according to different categories of emojis, where each category has one or more possible matches.

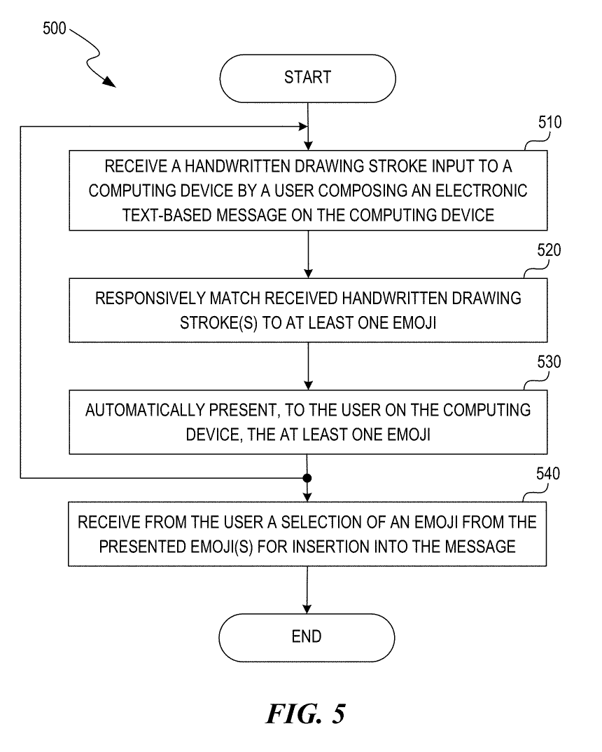

Further, as described above in connection with FIGS. 2 and 3, the hand-drawn emoji matching system 140 may be configured to dynamically identify matching emoji options as strokes of a handwritten drawing input are being input by the user. FIG. 5 is a flow diagram illustrating a method 500 for matching handwritten drawing strokes to emojis as strokes are entered. By way of example, the method 500 is performed by the hand-drawn emoji matching system 140. However, in other embodiments, the method 500 may be performed by any suitable processing system (e.g., implemented in the form of processor(s) and stored program instructions executed by the processor(s)) arranged to carry out functions of the method 500. (In general, the terms “stroke” and “handwritten drawing stroke” are used herein interchangeably.)

At block 510, the hand-drawn emoji matching system 140 receives a handwritten drawing stroke input to a computing device by a user composing an electronic text based message on the computing device. At block 520, the hand-drawn emoji matching system 140 responsively matches handwritten drawing stroke(s) received by the hand-drawn emoji matching system 140 to at least one emoji. For instance, the handwritten drawing stroke received at block 510 may be a first handwritten drawing stroke initially input by the user (e.g. a circle), and at block 520, the hand-drawn emoji matching system 140 may responsively match the first handwritten drawing stroke to one or more first emojis (e.g. match to a smiley-face emoji).

Then, at block 530, the hand-drawn emoji matching system 140 may automatically present the at least one emoji to the user on the computing device. The presented emoji(s) are selectable by the user for insertion into the electronic text-based message, without the need to enter any further strokes. As such, if the user sees an emoji that the user desires to insert into the electronic text-based message, at block 540, the hand-drawn emoji matching system 140 may receive from the user a selection of an emoji (e.g., one or more emojis) from the presented emoji(s) for insertion into the message.

However, the method 500 enables the user to continue to input one or more additional handwritten drawing strokes if the presented emoji(s) do not include an emoji desired by the user, the emoji matches are too numerous to choose from, etc. As such, the method 500 may return to block 510 at which the user inputs a next second handwritten drawing stroke. At block 520, the hand-drawn emoji matching system 140 responsively matches the received handwritten drawing strokes, i.e., the first and second handwritten drawing strokes, to one or more second emojis. As noted above, when the hand-drawn emoji matching system 140 processes together more strokes (e.g., the first handwritten drawing stroke and the second handwritten drawing stroke), the hand-drawn emoji matching system 140 may increase a likelihood of identifying emoji options that are likely to include an emoji desired by the user.

Again, at block 530, the hand-drawn emoji matching system 140 may automatically present the second emoji(s) to the user. The second emoji(s) presented may include at least one emoji different from the emoji(s) presented previously in response to the first handwritten drawing stroke. Alternatively or additionally, the second emoji(s) may be a subset of the emojis presented previously.

The second emoji(s) presented following the receipt of the next handwritten drawing stroke are again selectable by the user for insertion into the electronic text-based message. As such, if the user sees an emoji that the user desires to insert into the electronic text-based message, at block 540, the hand-drawn emoji matching system 140 may receive from the user a selection of an emoji (e.g., one or more emojis) from the second presented emoji(s) for insertion into the message. Accordingly, the process of FIG. 5 may be repeated with each additional handwritten drawing stroke input by the user. The method 500 ends once the hand-drawn emoji matching system 140 receives from the user a selection of an emoji (e.g., one or more emojis) from those presented, at block 540.

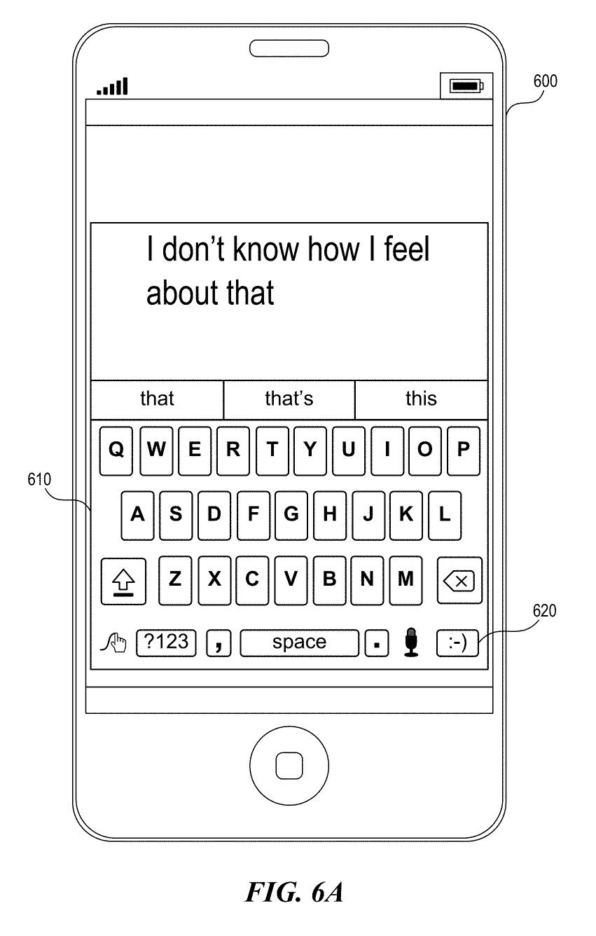

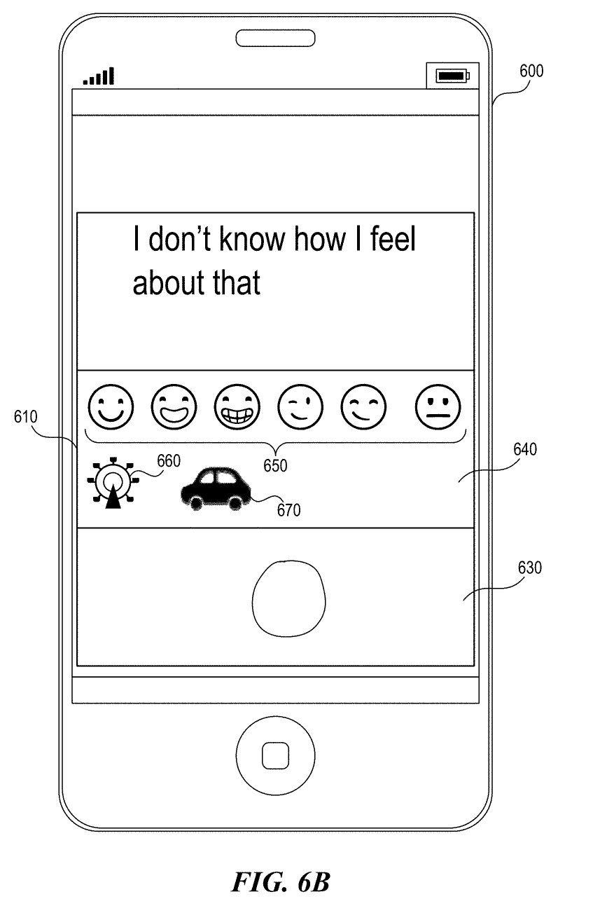

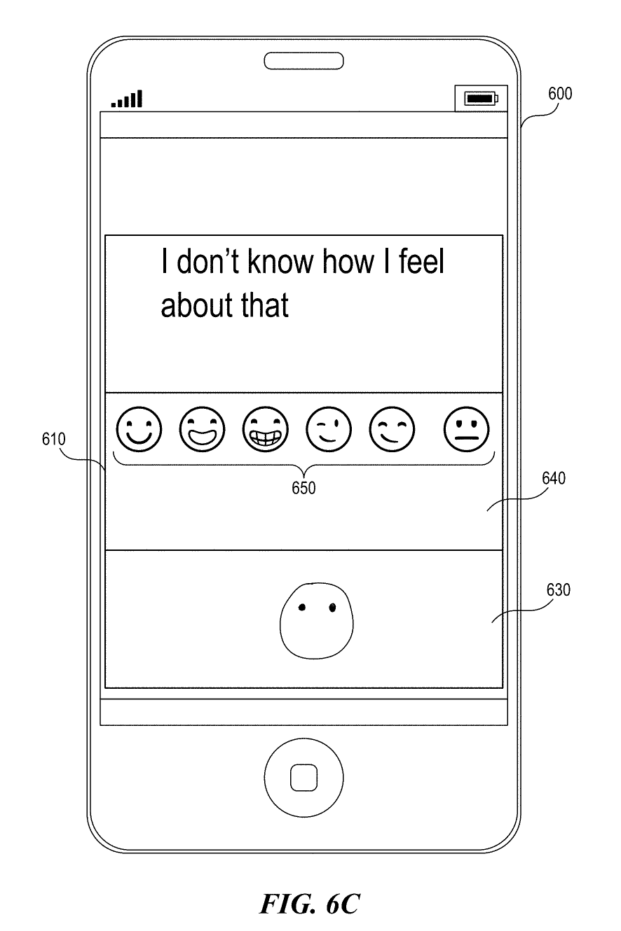

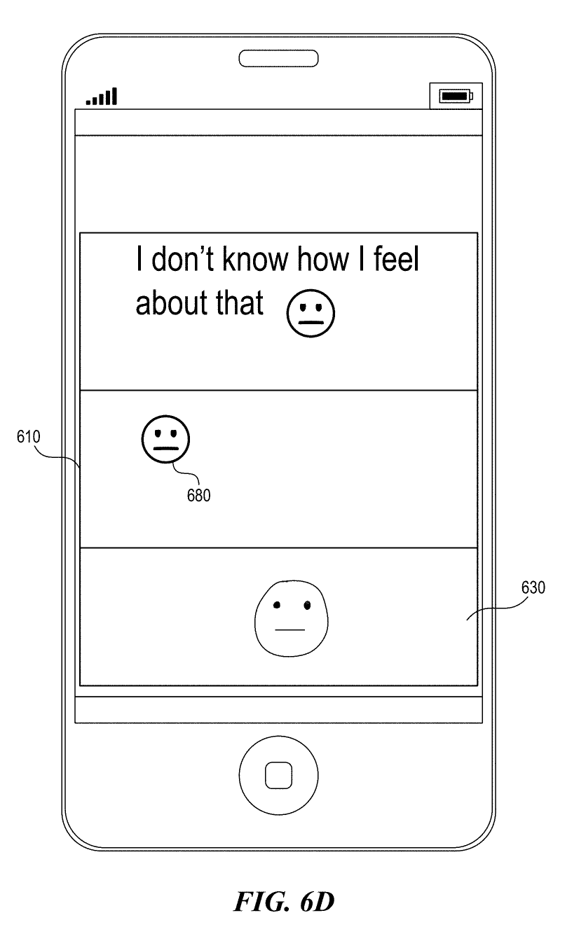

The methods 400 and 500 will now be illustrated by way of examples. FIG. 6A illustrates a touch-sensitive mobile device on which a user provides a handwritten drawing input, such as using a finger or a touchscreen-suitable input device (e.g., a stylus). By way of example, the user may be composing a text message on a touch-sensitive mobile device 600, and may invoke a virtual keyboard application 610 residing on the touch-sensitive mobile device 600. As the user composes the text message (e.g., “I don't know how I feel about that,” as in FIG. 6A), the user may want to insert an emoji corresponding to a facial expression to add an emotional context to the text message.

In one illustrative embodiment, the user may touch a user-selectable emoji symbol 620 on the virtual keyboard application 610, which, in turn, may bring up a handwritten drawing-input screen via which the user can provide a handwritten drawing input intended to represent the emoji. However, the handwritten drawing-input screen may be invoked in other ways, e.g., it may be possible to provide the handwritten drawing input via a screen associated with a messaging application that generates the text message.

As described hereinbefore, the hand-drawn emoji matching system 140 may dynamically identify and present to the user matching emoji(s) as strokes of the handwritten drawing input are being input by the user. To illustrate, FIGS. 6B-6D depict examples of a user interface of the touch-sensitive mobile device 600 for presenting matching emojis based on the handwritten drawing input. As noted above in connection with FIG. 6A, the user may select the emoji symbol 620 on the virtual keyboard application 610, which, in turn, may bring up a handwritten drawing-input screen, such as a handwritten drawing-input screen 630 shown in FIG. 6B.

As shown in FIG. 6B, the user may first draw on the handwritten drawing-input screen 630 one or more strokes representing a circle. In response, the hand-drawn emoji matching system 140 may search for emojis whose features may include or resemble a circle. More specifically, the hand-drawn emoji matching system 140 may search for emoji templates that include stroke data corresponding to a circle. By way of example, the system 140 may match the circle to multiple facial-expression emojis 650, a “ferris wheel” emoji 660, and a “car” emoji 670. As shown in FIG. 6B, those results may be presented in an emoji selection bar 640. In this regard, the multiple facial-expression emojis 650 may be grouped together (e.g., in a single row, as shown, and/or the like) as belonging to the same category of emojis.

As the emoji matches are presented, the user may be able to find and select an emoji corresponding to an emoji the user desires to insert into the text message. However, if the emoji options are too numerous or the desired emoji is not among the presented matches, the hand-drawn emoji matching system 140 will continue to analyze additional strokes input by the user, and search for matching emoji options. As the user draws additional stroke(s) on the handwritten drawing-input screen 630, a confidence level or probability of finding the right emoji increases. Hence, with additional stroke(s), the hand-drawn emoji matching system 140 may identify more relevant emoji options for the user to select from.

By way of example, the user may subsequently draw two dots inside the circle, as depicted in FIG. 6C. Based on a sequence of strokes received so far, the hand-drawn emoji matching system 140 may determine that the user's input likely represents at least one of facial-expression emojis. Hence, in response to the receipt of strokes representing the two dots, the hand-drawn emoji matching system 140 eliminates the “ferris wheel” emoji 660 and the “car” emoji 670 from the emoji selection bar 640. However, an ambiguity may still exist as to which of the multiple facial-expression emojis the user intends to insert: one of many smiling faces, a grinning face, a winking face, a smirking face, a neutral face, etc.

As shown in FIG. 6D, the user may complete the handwritten drawing input by drawing a straight line inside the circle. In response to the receipt of an additional stroke representing the line, the hand-drawn emoji matching system 140 may identify a “neutral face” emoji as the most likely match and eliminate other emoji options from the results presented to the user. By way of example, a “neutral face” emoji 680 is the only emoji presented in the emoji selection bar 640. The user can then select the emoji 680 for insertion into the text message. The user may, for example, tap on the emoji 680 to select it and add it to the text of the message, as shown in FIG. 6D. Of course, other methods of emoji selection and insertion into the message are possible as well.

Note that although the example of FIGS. 6A-6D assumes that the hand-drawn emoji matching system 140 dynamically identifies possible emoji matches based on successive strokes of the user's handwritten drawing input, in other embodiments, the hand-drawn emoji matching system 140 may be configured to execute this dynamic process in the backend only and present only final emoji matche(s) to the user. Yet in other embodiments, the hand-drawn emoji matching system 140 may perform stroke analysis and matching after all of the strokes are input by the user. It may then present final emoji matches(s) to the user.

As illustrated in the above example, inputting additional strokes may resolve an ambiguity as to which emoji character(s) user's hand-drawn emoji likely represents. However, situations may arise when the results generated by the hand-drawn emoji matching system 140 may be still too numerous and/or ambiguous. Hence, in some embodiments, the hand-drawn emoji matching system 140 may be configured to cooperate or be integrated with another recognition engine, such as a prediction engine (e.g., XT9® available from Nuance Corporation), to optimize presentation of emoji options based on context of an electronic text-based message being composed by a user and/or previous user behavior. For instance, in cooperation with a suitable prediction engine, the hand-drawn emoji matching system 140 may be configured to output “strings” or different variants of a particular emoji matched to a user's handwritten drawing input (e.g., different variations of a “smiley-kiss” emoji) depending on the user's behavior or predictive engine algorithms.

For instance, the hand-drawn emoji matching system 140 may be integrated with the XT9® engine that can consider context of the message (e.g., based on preceding words), map emojis to text based on semantic meaning of words entered, and/or previous user corrections. Another example of a suitable system that may be configured to cooperate or be integrated with the hand-drawn emoji matching system 140 is a handwriting recognition system that can infer emoji suggestions based on a text a user has entered, such as a determined sentiment, tone or other inferred intent of a message. Further details of such system are described in assignee's commonly-owned co-pending U.S. patent application Ser. No. 15/167,150, entitled “SUGGESTING EMOJIS TO USERS FOR INSERTION INTO TEXT-BASED MESSAGES,” filed on May 27, 2016, the entirety of which is hereby incorporated by reference.

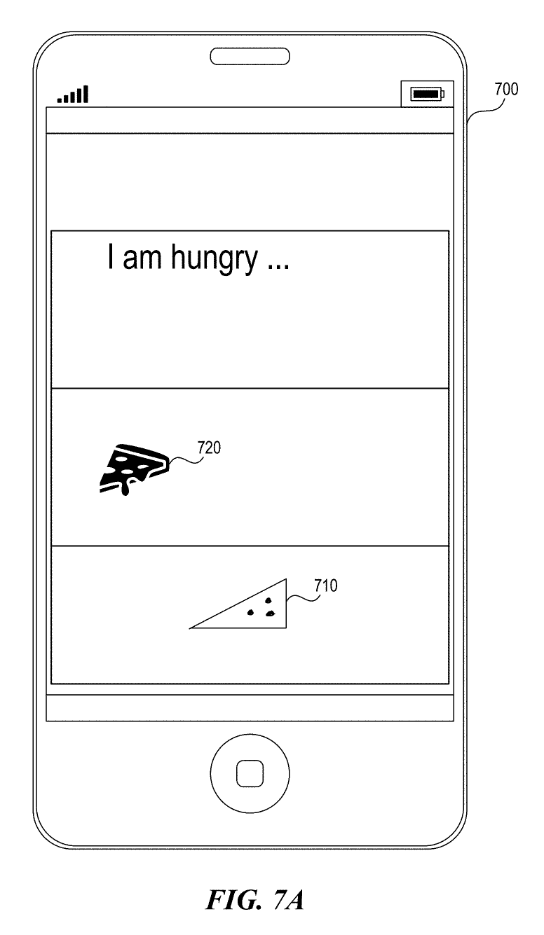

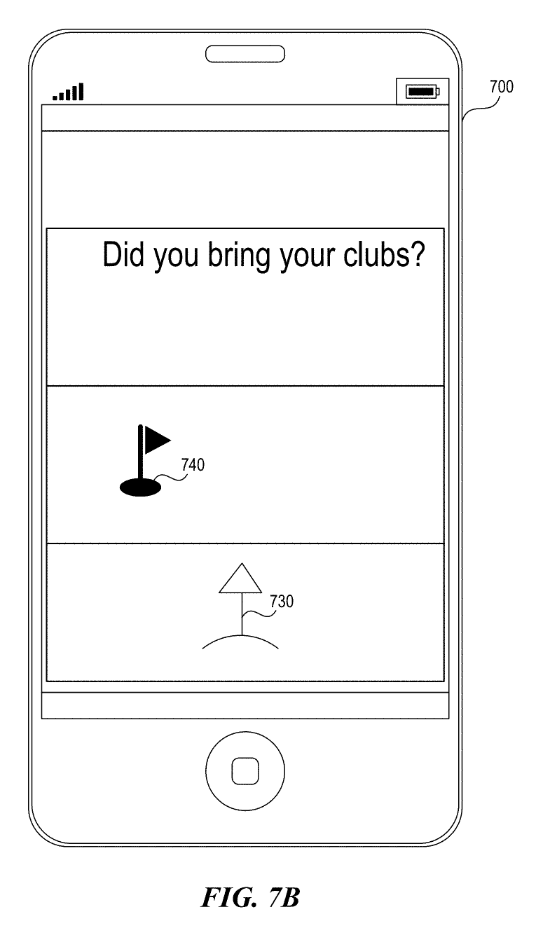

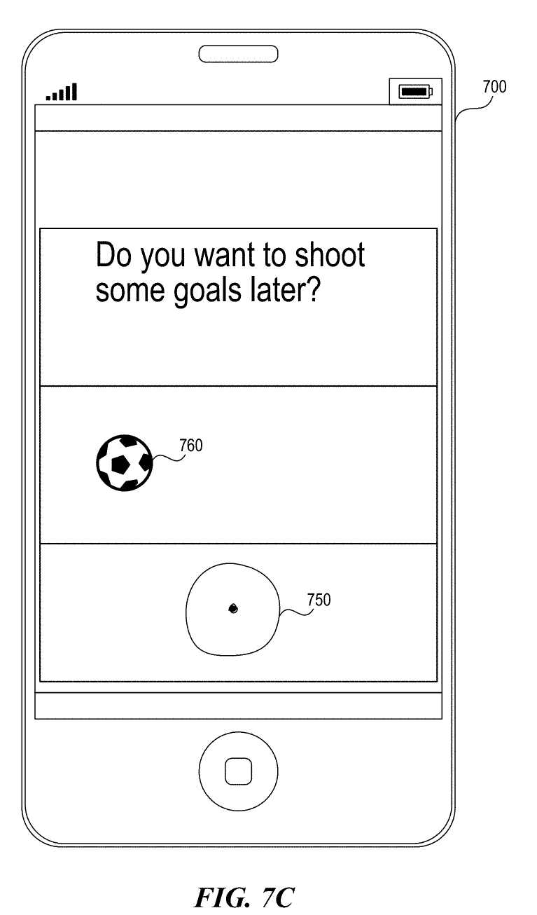

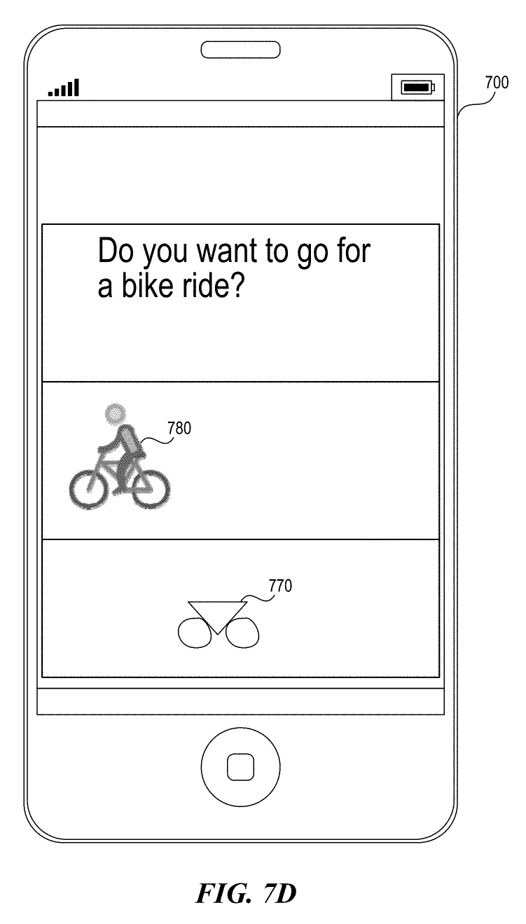

FIGS. 7A-7D illustrate additional examples of a user interface of a touch-sensitive mobile device for presenting a matching emoji based on a hand-drawn emoji representation.

FIG. 7A depicts a user interface of a touch-sensitive mobile device 700 after a user provides a handwritten drawing input 710 in the form of a triangle with multiple dots inside the triangle. As a result of the stroke analysis as described herein, the hand-drawn emoji matching system 140 may match that input to at least one “pizza slice” emoji 720.

FIG. 7B depicts a user interface of the touch-sensitive mobile device 700 after the user provides a handwritten drawing input 730 in the form of a curve resembling a bump and a line topped with a triangle. As a result of the stroke analysis as described herein, the hand-drawn emoji matching system 140 may match that input to at least one “flag-in-hole” emoji 740.

FIG. 7C depicts a user interface of the touch-sensitive mobile device 700 after the user provides a handwritten drawing input 750 in the form of a circle with a single dot inside the circle. As a result of the stroke analysis as described herein, the hand-drawn emoji matching system 140 may match that input to at least one “soccer ball” emoji 760.

Finally, FIG. 7D depicts a user interface of the touch-sensitive mobile device 700 after the user provides a handwritten drawing input 770 in the form of multiple circles and a triangle. As a result of the stroke analysis as described herein, the hand-drawn emoji matching system 140 may match that input to at least one “bicyclist” emoji 780.

As noted hereinbefore, searching for a desired emoji may be time consuming. Advantageously, with the benefits of the present technology, the process of finding the desired emoji may be simplified. A user may simply draw a desired emoji using handwriting techniques and then select a matching emoji from one or more emoji options identified by the system based on, for instance, predetermined (e.g., typical) emoji hand-drawn representations.

### Illustrative Computing Device

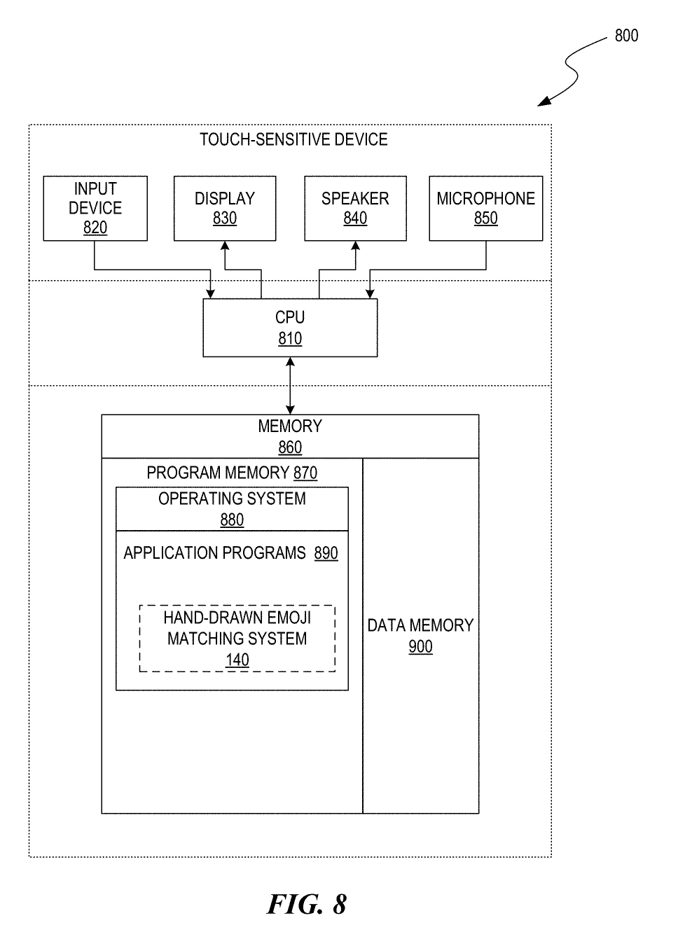

FIG. 8 is a simplified system block diagram of hardware components of a touch-sensitive device for implementing the hand-drawn emoji matching system 140. A touch-sensitive device 700 includes one or more input devices 820 that provide input to a processor 810 (e.g., a CPU), notifying it of actions performed by a user, such as touch inputs received from the user. The actions are typically mediated by a hardware controller that interprets signals received from the input device and communicates information to the processor using a known communication protocol. The input devices 820 include, for example, any suitable type of a touchscreen (e.g., a resistive or capacitive touchscreen), a touchpad (e.g., a touchpad that uses capacitive sensing or conductance sensing), a mouse, and/or the like. Other input devices that may employ the present system may be appropriate.

The processor 810 may be a single processing unit or multiple processing units in a device or distributed across multiple devices. Similarly, the processor 810 communicates with a hardware controller for a display 830 on which text and graphics, such as emojis, are displayed. In some implementations, the display 830 includes the input device 820 as part of the display, such as when the input device 820 is a touchscreen. In some implementations, the display 830 is separate from the input device 820. For example, a touchpad (or trackpad) (e.g., a Force Touch trackpad) may be used as the input device 820, and a separate or standalone display device that is distinct from the input device 820 may be used as the display 830. Some examples of standalone display devices include an LCD display screen and an LED display screen. Further, in some implementations, the input device 820 may be an external input device coupled with the touch-sensitive device 800, an example of which includes a pen/graphics tablet (e.g., a pen tablet available from Wacom Company).

Optionally, a speaker 840 is also coupled to the processor 810 so that any appropriate auditory signals can be passed on to the user. In some implementations, the touch-sensitive device 800 includes a microphone 850 that is also coupled to the processor 810 so that any spoken input can be received from the user.

The processor 810 has access to a memory 860, which may include a combination of temporary and/or permanent storage, and both read-only and writable memory (random access memory or RAM), read-only memory (ROM), writable non-volatile memory, such as flash memory, hard drives, floppy disks, and so forth. The memory 860 includes program memory 870 that contains all programs and software, such as an operating system 880 and any other application programs 890 including, e.g., a messaging application, a virtual keyboard application, and a program code for executing by the processor 810 various functions of the hand-drawn emoji matching system 140 as described herein. As noted above, the hand-drawn emoji matching system 140 may be integrated with the virtual keyboard application, any suitable text-input application, the messaging application itself, or may be a stand-alone application within the operating system 880 of the touch-sensitive device 800. The memory 860 may also include data memory 900 that includes any configuration data, settings, user options and preferences that may be needed by the program memory 870, or by any element of the touch-sensitive device 800. In some implementations, the data memory 900 may also include local dynamic emoji template database(s) to which user/application can add customized emoji templates as described hereinbefore. Such local databases can be stored in a persistent storage for loading at a later time.

Although not illustrated, in some implementations, the touch-sensitive device 800 also includes a communication device (e.g., a transceiver) capable of communicating wirelessly with a base station or access point using a wireless mobile telephone standard/protocol, such as the Global System for Mobile Communications (GSM), Code Division Multiple Access (CDMA), Long Term Evolution (LTE), IEEE 802.11, or any another suitable wireless standard/protocol. The communication device may also communicate with another device or a server through a network using, for example, TCP/IP protocols. For example, the touch-sensitive device 800 may utilize the communication device to send information regarding a use of the hand-drawn emoji matching system 140 to a remote server and receive information (e.g., periodic emoji database updates) from the remote server.

### Conclusion

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Modules described herein may be executed by a general-purpose computer, e.g., a server computer, wireless device, or personal computer. Those skilled in the relevant art will appreciate that aspects of the invention can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” “host,” “host system,” and the like, are generally used interchangeably herein and refer to any of the above devices and systems, as well as any data processor. Furthermore, aspects of the invention can be embodied in a special purpose computer or data processor that is specifically programmed, configured, or constructed to perform one or more of the computer-executable instructions explained in detail herein.

Software and other modules may be accessible via local memory, a network, a browser, or other application in an ASP context, or via another means suitable for the purposes described herein. Examples of the technology can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein.

Examples of the technology may be stored or distributed on computer-readable media, including magnetically or optically readable computer disks, hard-wired or preprogrammed chips (e.g., EEPROM semiconductor chips), nanotechnology memory, biological memory, or other data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the systems described herein. The elements and acts of the various examples described above can be combined to provide further implementations of the invention.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention.

These and other changes can be made to the invention in light of the above Detailed Description. While the above description describes certain examples of the invention and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the technology are presented below in certain claim forms, but the applicant contemplates the various aspects of the technology in any number of claim forms. For example, while only one aspect of the technology is recited as a computer-readable storage medium claim, other aspects may likewise be embodied as a computer-readable storage medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A method implemented by at least one processor to insert an emoji into an electronic text-based message, the method comprising:
receiving a handwritten drawing input from a user composing an electronic text-based message on a computing device,
wherein the handwritten drawing input is to represent an emoji for insertion into the electronic text-based message, and
wherein the handwritten drawing input comprises a series of strokes input to the computing device by the user;
analyzing the series of strokes; and
matching the analyzed series of strokes to at least one emoji in a set of emojis,
wherein the at least one emoji is selectable by the user for insertion into the electronic text-based message.

2. The method of claim 1, further comprising receiving from the user a selection of one or more emojis from multiple displayed emojis to be inserted into the electronic text-based message.

3. The method of claim 1, wherein the handwritten drawing input is provided by the user via a touchscreen and a virtual keyboard application on the computing device.

4. The method of claim 1, wherein at least two strokes of the series of strokes are input to the computing device by the user simultaneously.

5. The method of claim 4, wherein the at least two strokes are input via a multi-touch input.

6. The method of claim 1, wherein the at least one emoji comprises multiple emojis, the method further comprising:
presenting, to the user on the computing device, the multiple emojis in an order that is based on popularity of respective emojis.

7. The method of claim 1, wherein:
the at least one emoji comprises multiple emojis, and
the multiple emojis are organized for presentation to the user according to different categories of emojis.

8. The method of claim 1, wherein the analyzing of the series of strokes and the matching of the analyzed series of strokes to the at least one emoji in the set of emojis are performed dynamically as the handwritten drawing input is being received from the user.

9. The method of claim 8, wherein matching the analyzed series of strokes to the at least one emoji in the set of emojis includes:
in response to a receipt of a first stroke, (i) matching the first stroke to one or more first emojis in the set of emojis and (ii) automatically presenting, to the user on the computing device, the one or more first emojis; and
in response to a receipt of a second stroke, (i) matching the first stroke and the second stroke to one or more second emojis in the set of emojis and (ii) automatically presenting, to the user on the computing device, the one or more second emojis.

10. The method of claim 9, wherein the one or more second emojis includes at least one emoji different from the one or more first emojis.

11. The method of claim 9, wherein the one or more second emojis is a subset of multiple first emojis.

12. A non-transitory computer-readable storage medium having instructions stored thereon that, when executed by a computing device, cause the computing device to carry out a method for inserting an emoji into an electronic text-based message, the method comprising:
receiving at least a first handwritten drawing stroke input to a computing device by a user composing an electronic text-based message on the computing device; and
responsively matching the received first handwritten drawing stroke to at least one first emoji in a set of emojis.

13. The medium of claim 12, wherein the method further comprises:
automatically presenting, to the user on the computing device, the at least one first emoji,
wherein the at least one first emoji presented to the user is selectable by the user for insertion into the electronic text-based message.

14. The medium of claim 13, wherein the method further comprises:
subsequent to presenting the at least one first emoji to the user, receiving a second handwritten drawing stroke input to the computing device by the user; and
responsively matching the received first and second handwritten drawing strokes to at least one second emoji in the set of emojis.

15. The medium of claim 14, wherein the method further comprises:
automatically presenting, to the user on the computing device, the at least one second emoji,
wherein the at least one second emoji is selectable by the user for insertion into the electronic text-based message.

16. A system, implemented on a computing device, for inserting an emoji into an electronic text-based message, the system comprising:
at least one processor;
at least one memory coupled to the at least one processor; and
program instructions stored in the at least one memory to cause the at least one processor to:
receive a handwritten drawing input from a user composing an electronic text-based message on the computing device,
wherein the handwritten drawing input is to represent an emoji for insertion into the electronic text-based message, and
wherein the handwritten drawing input comprises a series of strokes input to the computing device by the user;
analyze the series of strokes; and
match the analyzed series of strokes to at least one emoji in a set of emojis,
wherein the at least one emoji is selectable by the user for insertion into the electronic text-based message.

17. The system of claim 16, wherein:
the set of emojis is held in a database stored in the at least one memory, and
the database stores stroke data associated with corresponding emoji characters.

18. The system of claim 17, wherein:
the database stores multiple emoji templates corresponding to the emoji characters,
each emoji template includes a Unicode value representing an emoji character associated with the emoji template, and
a first Unicode value representing a given emoji character is associated with multiple emoji templates that respectively include different stroke data associated with the given emoji character.

19. The system of claim 17, wherein the database is configured to be updated remotely on a periodic basis based on information provided, to a remote entity, by multiple computing devices on which the system is implemented.

20. The system of claim 16, further comprising a touchscreen input device configured to receive the handwritten drawing input from the user.
